(19) United States
(12) Patent Application Publication
(10) Pub. No.: US 2023/0375738 A1
(43) Pub. Date: Nov. 23, 2023

(54) CONSTANT CURRENT METAL DETECTOR WITH DRIVEN TRANSMIT COIL

(71) Applicant: MINELAB ELECTRONICS PTY LIMITED, Mawson Lakes (AU)

(72) Inventor: Bruce Halcro CANDY, Basket Range (AU)

(21) Appl. No.: 18/353,711

(22) Filed: Jul. 17, 2023

Related U.S. Application Data
(63) Continuation of application No. 17/888,081, filed on Aug. 15, 2022, now abandoned.
Application No. 17/888,081 is a continuation of application No. 17/191,261, filed on Mar. 3, 2021, now abandoned.
Application No. 17/191,261 is a continuation of application No. 16/890,773, filed on Jun. 2, 2020, now abandoned.
Application No. 16/890,773 is a continuation of application No. 15/820,482, filed on Nov. 22, 2017, now abandoned.
Application No. 15/820,482 is a continuation of application No. 14/225,908, filed on Mar. 26, 2014, now abandoned.
Application No. 14/225,908 is a continuation-in-part of application No. 13/720,828, filed on Dec. 19, 2012, now Pat. No. 9,250,348.
Application No. 13/720,828 is a continuation-in-part of application No. 13/326,179, filed on Dec. 14, 2011, now Pat. No. 9,348,053.
Application No. 13/326,179 is a continuation-in-part of application No. 12/621,427, filed on Nov. 18, 2009, now abandoned.
Application No. 12/621,427 is a continuation-in-part of application No. PCT/AU09/00836, filed on Jun. 29, 2009.
Application No. 13/326,179 is a continuation-in-part of application No. PCT/AU2011/000738, filed on Jun. 17, 2011.

(30) Foreign Application Priority Data
Jun. 27, 2008 (AU) 2008903280
Aug. 29, 2008 (AU) 2008904489
Feb. 18, 2009 (AU) 2009900687
Jun. 18, 2010 (AU) 2010902666
Sep. 14, 2010 (AU) 2010904134
Dec. 19, 2011 (AU) 2011905296
Dec. 23, 2011 (AU) 2011905417

(51) Int. Cl. G01V 3/10

(52) U.S. Cl. CPC G01V 3/104

(57) ABSTRACT

A metal detector transmitting, through a transmit coil, a repeating transmit signal cycle, which includes at least one receive period and at least one non-zero transmit coil reactive voltage period; and sensing a current in the transmit coil during at least one receive period to control a magnitude and/or duration of the at least one non-zero transmit coil reactive voltage period such that the average value of the current during at least one receive period of every repeating transmit signal cycle is substantially constant from cycle to cycle, and the current during at least one receive period is substantially independent of the inductance of the transmit coil.

### CROSS REFERENCE TO RELATED APPLICATIONS

This application is a Continuation of co-pending application Ser. No. 17/191,261, filed on Mar. 3, 2021, which is a Continuation of co-pending application Ser. No. 16/890,773, filed on Jun. 2, 2020, which is a Continuation of abandoned application Ser. No. 15/820,482, filed on Nov. 22, 2017, which is a Continuation of abandoned application Ser. No. 14/225,908, filed on Mar. 26, 2014, which is a Continuation-in-part of abandoned application Ser. No. 12/621,427, filed on Nov. 18, 2009, which is a Continuation of international Application No. PCT/AU2009/00836, filed on Jun. 29, 2009, and said Ser. No. 14/225,908 is a Continuation-in-part of patented application Ser. No. 13/326,179, filed on Dec. 14, 2011 (now U.S. Pat. No. 9,348,053), which is a Continuation-in-part of international Application No. PCT/AU2011/00738, filed on Jun. 17, 2011, said Ser. No. 14/225,908 is a Continuation-in-part of patented application Ser. No. 13/720,828, filed on Dec. 19, 2012 (now U.S. Pat. No. 9,250,348), for which priority is claimed under 35 U.S.C. § 120; and this application claims priority of Application No. 2011905417 filed in Australia on Dec. 23, 2011, Application No. 2011905296 filed in Australia on Dec. 19, 2011, Application No. 2010904134 filed in Australia on Sep. 14, 2010, Application No. 2010902666 filed in Australia on Jun. 18, 2020, Application No. 2009900687 filed in Australia on Feb. 18, 2009, Application No. 2008904489 filed in Australia on Aug. 29, 2008, and Application No. 2008903280 filed in Australia on Jun. 27, 2008, under 35 U.S.C. § 119; the entire contents of all of which are hereby incorporated by reference.

### TECHNICAL FIELD

This invention relates to metal detectors that are time-domain detectors.

### INCORPORATION BY REFERENCE

The following documents are referred to in the present specification:

U.S. Pat. No. 5,576,624 entitled ‘Pulse induction time domain metal detector’;

U.S. Pat. No. 6,636,044 entitled ‘Ground mineralization rejecting metal detector (receive signal weighting)’;

U.S. Pat. No. 6,653,838 entitled ‘Ground mineralization rejecting metal detector (transmit signal)’;

U.S. Pat. No. 6,686,742 entitled ‘Ground mineralization rejecting metal detector (power saving)’;

US Patent Application No. 2008/0048661 entitled ‘Rectangular-wave transmitting metal detector’;

International Patent Publication No. WO/2008/006178 entitled ‘Metal detector having constant reactive transmit voltage applied to a transmit coil’;

International Patent Publication No. 2WO/2009/062230 entitled ‘Metal detector with improved magnetic response application’;

International Patent Publication No. WO/2008/040089 entitled ‘Metal detector with improved magnetic soil response cancellation’;

International Patent Publication No. WO/2005/047932 entitled ‘Multi-frequency metal detector having constant reactive transmit voltage applied to a transmit coil’.

The entire content of each of these documents is hereby incorporated by reference.

### BACKGROUND

The general forms of most metal detectors which interrogate soils are either hand-held battery operated units, conveyor-mounted units, or vehicle-mounted units. Examples of hand-held battery operated units include detectors used to locate gold, explosive land mines or ordnance, coins and treasure. An example of a conveyor-mounted unit includes a fine gold detector used in ore mining operations, and an example of a vehicle-mounted unit includes a detector to locate buried land mines.

These electronic metal detectors usually consist of transmit electronics generating a repeating transmit signal cycle, which is applied to an inductor, a transmit coil, which transmits a resulting alternating magnetic field.

Time domain metal detectors usually include switching electronics within the transmit electronics, which switches various voltages from various power sources to the transmit coil for various periods in a repeating transmit signal cycle.

Metal detectors contain receive electronics which processes a receive magnetic field to produce an indicator output, the indicator output at least indicating the presence of at least some metal targets under the influence of the transmitted magnetic field.

Traditional pulse induction metal detectors are time domain detectors, having a plurality of switches for switching at least first and second voltages from power sources, and zero volts for various durations, to generate a repeating transmit signal cycle with a fundamental frequency usually being in the range from tens of Hertz to several kiloHertz. The second voltage from a second power source is usually a low negative voltage, −6V for example, and is switched to the transmit coil during a low-voltage period. Disconnection of the second source from the transmit coil is followed immediately by a back-emf period (a high-voltage period) of high first voltage, for example +180V, switched to a first power source usually via a diode that is forward biased during this period, and a zero-voltage period immediately following the high-voltage period. The transmit electronics presents a low source impedance to the transmit coil during the low-voltage period and back-emf period, assuming that the coil is connected to the first power source, but presents a high impedance when the critically damped decay of the back-emf occurs, and during the zero-voltage period when no transmit coil current flows and a magnetic signal is received. During these periods of high impedance, output impedance of the said switching electronics is usually a function of the capacitance of the switching electronics in parallel with a resistor (e.g. 500Ω) whose value is usually selected to critically damp the self-resonance of the transmit coil. As this period of relatively high impedance commences with a period of decay of a pulse induction back-emf, the received signal will contain a reactive component (X) during this period of decay. Hence, to avoid contaminating the receive signal with this X component, usually most, if not all, of the receive signal processing of sampling, or synchronous demodulation, is delayed so as to occur during that period of zero-voltage occurring after the back-emf has decayed.

For the sake of simplicity, assume both conventional pulse induction transmit and receive coils share a critical damping time constant of τ. The transient output from the receive coil, in the almost ideal case of zero capacitive coupling but finite mutual inductance between the transmit and receive coils, is of the form

$$k \{ 1 + ω t + \frac{{( ω t )}^{2}}{2} + \frac{{( ω t )}^{3}}{6} \} {e}^{- ω t} \qquad ( 1 )$$

where ω=1/π; coefficient k depends upon both the magnitude of back-emf and the coupling coefficient; t=0 coincides with the commencement of the decay of the back-emf, and the decay of the back-emf is of the form V₀(1+ωt)e^{-ωt}). Here, it is assumed that the duration of the back-emf period is >>t.

Many metal targets, such as small gold nuggets and fine gold chains, harbour eddy currents with short decay periods. Delay of the sampling, or synchronous demodulation, of the receive signal after the back-emf periods results in reduced sensitivity to these fast decay targets. However, the delay cannot be made too short because contamination of the receive signal with X components of the receive signal occurs if the receive processing occurs when the value of Equation (1) is significant. Hence, if the value of Equation (1) can be reduced, i.e the time constant of critical damping is reduced, targets with faster time constants targets can be detected without contamination of the receive signal with X.

Contemporaneous pulse induction metal detectors are not power-efficient, even with remedial components described in U.S. Pat. No. 6,686,742. For example, some pulse induction metal detectors include a diode in series with the transmit coil and switching electronics, that diode reducing power efficiency. As well, the transmit coil damping resistor will necessarily dissipate some power, also reducing the efficiency.

It is an aim of this invention to reduce, or eliminate, the above problems, or at least offer an alternative arrangement for a metal detector.

WO/2008/006178 discloses a metal detector which produces a constant reactive voltage, throughout most of its repeating transmit signal cycle, that is unchanged when the inductance of the transmit coil is modulated by magnetically permeable soils as the transmit coil is passed over them. Receive periods occur during periods of finite transmit coil current and zero reactive transmit coil voltage.

The present invention also produces periods of zero transmit reactive voltage with finite transmit coil current. Whilst WO/2008/006178 discloses a theoretically optimal condition, the invention described herein offers a practical compromise which nevertheless produces satisfactory results.

### BRIEF SUMMARY OF THE INVENTION

According to a first aspect of the invention, there is provided a metal detector used for detecting a metallic target in a soil comprising: a) transmit electronics having a plurality of switches for generating a repeating transmit signal cycle, the repeating transmit signal cycle including at least one receive period and at least one non zero transmit coil reactive voltage period, the at least one non zero transmit coil reactive voltage period is different from the at least one receive period; b) a transmit coil having an inductance connected to the transmit electronics for receiving the repeating transmit signal cycle and generating a transmitted magnetic field; c) a receive coil for receiving a received magnetic field during at least one receive period and providing a received signal induced by the received magnetic field; d) one or more negative feedback loops for sensing a current in the transmit coil during the at least one receive period to provide a control signal, and based on the control signal, the one or more negative feedback loops control a magnitude of a voltage and/or duration of the at least one non zero transmit coil reactive voltage period; and e) receive electronics connected to the receive coil for processing the received signal during at least one receive period to produce an indicator output signal, the indicator output signal including a signal indicative of the presence of a metallic target in the soil; wherein when the inductance of the transmit coil is modulated by the soil during an operation of the metal detector, the one or more negative feedback loops change the magnitude of a voltage and/or duration of the at least one non zero transmit coil reactive voltage period to maintain an average value of the current during at least one receive period in a cycle to be substantially the same value as an average value of the current during at least one receive period in any other cycle.

According to a second aspect of the invention, there is provided a method for detecting a metallic target in a soil using a metal detector, the method comprising: a) generating a repeating transmit signal cycle, the repeating transmit signal cycle including at least one receive period and at least one non zero transmit coil reactive voltage period, the at least one non zero transmit coil reactive period is different from the at least one receive period; b) receiving the repeating transmit signal cycle using a transmit coil having an inductance connected to the transmit electronics for generating a transmitted magnetic field; c) receiving a received magnetic field using a receive coil during at least one receive period and providing a received signal induced by the received magnetic field; d) sensing a current in the transmit coil during at least one receive period to provide a control signal, and based on the control signal, controlling a magnitude of a voltage and/or duration of the at least one non zero transmit coil reactive voltage period; and e) processing the received signal during at least one receive period to produce an indicator output signal, the indicator output signal including a signal indicative of the presence of a metallic target in the soil; wherein when the inductance of the transmit coil is modulated by the soil during an operation of the metal detector, the step of controlling a magnitude of a voltage and/or duration of the at least one non zero transmit coil reactive voltage period includes changing the magnitude of a voltage and/or duration of the at least one non zero transmit coil reactive voltage period to maintain an average value of the current during at least one receive period in a cycle to be substantially the same value as an average value of the current during at least one receive period in any other cycle.

According to a third aspect of the invention, there is provided a computer readable medium comprising instructions for causing a processor to implement the method of the second aspect.

A detailed description of one or more embodiments of the invention is provided below, along with accompanying figures that illustrate, by way of example, the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practised according to the claims without some or all of these specific details. For the purpose of clarity, technical material that is known in the technical fields related to the invention has not been described in detail so that the present invention is not unnecessarily obscured.

Throughout this specification and the claims that follow, unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The term “constant” in this context of this description of embodiments means an approximately unvarying magnitude about a predetermined value. This predetermined value could be controlled and adjusted depending on different applications but would normally remain unchanged or “constant” during a use of the embodiment described. In the context of this application, variations of current smaller than 1 mA are considered to be constant or, more generally, considered to be substantially constant. In practice, effort has been put into achieving a maximum variation of 60 μA, but reasonable detection results can be achieved with a maximum variation of 1 mA.

When referring to an average voltage or current value being constant in the context of this description of embodiments, what is meant is that the average value of a voltage or current of a particular period in a cycle is of the same value as the average value of a voltage or current of the same particular period in another cycle.

The reference to any prior art in this specification is not, and should not be taken as, an acknowledgment or any form of suggestion that such prior art forms part of the common general knowledge of the technical field.

To assist with the understanding of this invention, reference will now be made to the drawings:

### BRIEF DESCRIPTION OF THE DRAWINGS

FIG. 1 depicts a general block diagram of a metal detector with a negative feedback loop to monitor and control the transmit coil current;

FIG. 2 depicts an example waveform of the repeating transmit signal cycle (a) with its corresponding transmit coil current square-wave (b); being one of the possible transmit waveforms generated by the electronic circuit depicted in block diagram in FIG. 3;

FIG. 3 depicts a block electronic circuit diagram of one embodiment of the invention with an electronic system capable of producing a repeating transmit signal cycle including low-voltage periods of simultaneously constant current and zero reactive voltage;

FIG. 4 depicts an example of a waveform of the repeating transmit signal cycle, in order to explain the concept of constant average current from cycle to cycle;

FIG. 5 depicts steps of operation of one embodiment of the present invention;

FIG. 6 depicts a block electronic circuit diagram of one embodiment of the invention with an electronic system capable of continuously producing a pulse induction-like waveform from a low impedance repeating transmit signal cycle source;

FIG. 7 depicts an example waveform of the repeating transmit signal cycle, which is a pulse induction-like waveform;

FIG. 8 depicts another example waveform of the repeating transmit signal cycle, which is a multi-voltage and multi-period waveform;

FIG. 9 depicts another example waveform of the repeating transmit signal cycle, which is a pulse induction-like symmetric bipolar system waveform; and

FIG. 10 depicts an alternative block electronic circuit diagram of the coil switching circuit suitable for bipolar transmission of the waveform shown in FIG. 9.

### DETAILED DESCRIPTION OF THE INVENTION

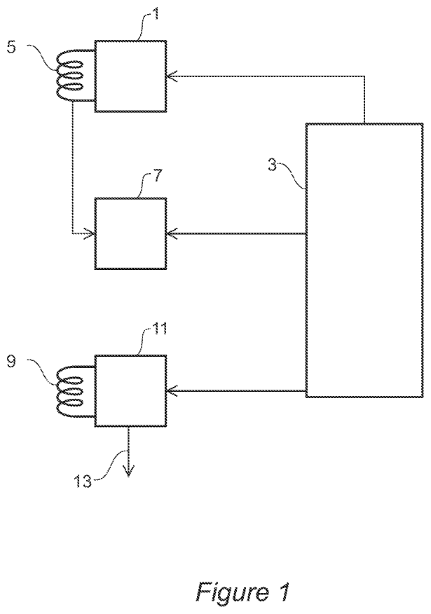

FIG. 1 is a block diagram showing the main parts of a metal detector. Transmit electronics 1 contains switches, and might also include linear elements controlled by timing electronics 3 to generate a repeating transmit signal cycle current in a transmit coil 5 connected to the transmit electronics 1. The transmit coil 5 generates, in response to the repeating transmit signal cycle from transmit electronics 1, a transmitted magnetic field, which is directed towards a soil medium (not shown), in which there might be metal targets. The physical form of the coil is well known to those skilled in the art and can take many forms. A negative feedback loop amplifier 7 senses the current in the transmit coil 5 and provides timing electronics 3 a control signal to control the duration of at least one period of the repeating transmit signal cycle and/or to control the magnitude of the voltage of at least one period of the repeating transmit signal cycle.

A receive coil 9, located in the vicinity of the soil medium, is connected to receive electronics 11. The received magnetic field induces a received signal in the receive coil 9 (an electromotive force (emf) signal) that is processed by receive electronics 11 to generate an indicator output signal 13 to indicate the presence of metals affected by the transmitted magnetic field.

Some of the functions of the receive electronics 11, such as those performed by the synchronous demodulators and any further processing, may be implemented in either software (such as a Digital Signal Processor (DSP) programmed into an Application Specific Integrated Circuit), or hardware such as an analogue circuitry and is typically provided as a combination of software and hardware, or both.

A basic form of the repeating transmit signal cycle of the present invention includes at least a non-zero transmit coil reactive voltage period and at least a receive period. The transmit coil reactive voltage is related to the transmit coil current through the relationship v=Ldi/dt, where v is the transmit coil reactive voltage, i is the transmit coil current and L is the effective inductance of the transmit coil. Hence, a non-zero reactive voltage across the purely inductive part of the transmit coil implies a changing current in the coil.

The applied voltage across a coil, u, equals Ldi/dt+Ri, where R is the effective transmit coil resistance. Note that it is obvious to a person skilled in the art that reactive voltage, v=Ldi/dt, is not equal to the applied voltage across the transmit coil.

A complex form of the repeating transmit signal cycle of the present invention may include more than one non-zero transmit reactive voltage period and more than one receive period. To differentiate the term “period” from the term “cycle”, unless indicated otherwise, the term “period” is used throughout this description to refer to a duration of time, for example, a low-voltage period means a duration of time when a low voltage is being applied. A “cycle” on the other hand generally means a series of “periods”, that series being regularly repeated. For example, if A represents a low-voltage period and B represents a high-voltage period, ABB would be recognised as a cycle for the series of ABBABBABB . . . , ABA would be recognised as a cycle for the series of ABAABAABA . . . , AB(−A)(−B) would be recognised as a cycle for the series of AB(−A)(−B) AB(−A)(−B) AB(−A)(−B) . . . .

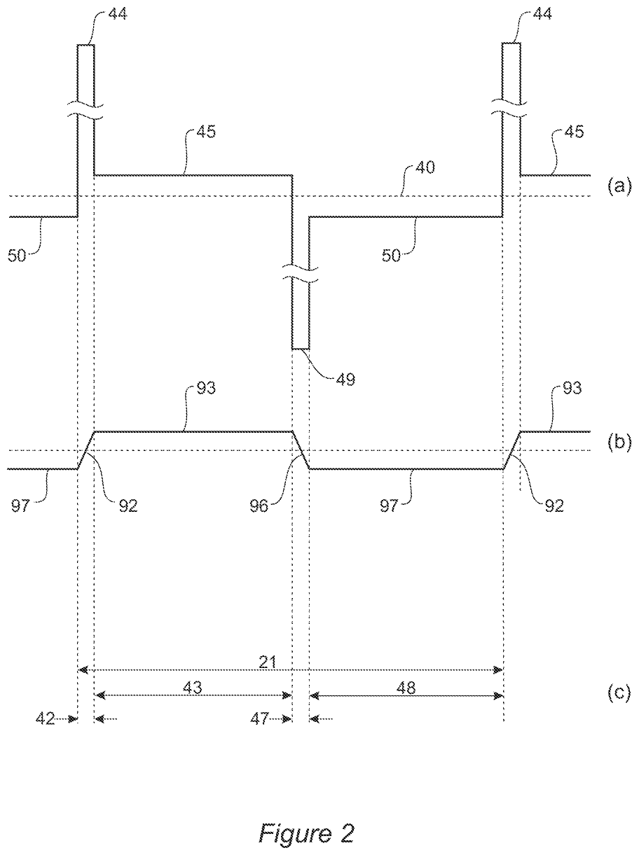

FIG. 2 shows an exemplary form of the repeating transmit signal cycle, where the repeating transmit signal cycle includes two different sequences, the first sequence includes a first high-voltage period 42 followed by a first low-voltage period 43, and the second sequence includes a second high-voltage period 47 followed by a second low-voltage period 48. The first and second low-voltage periods, 43 and 48, are the first and second receive periods respectively, and the second sequence is opposite in polarity to the first sequence. FIGS. 2 (a) and 2 (b) show the applied voltages and currents, respectively, of the repeating transmit signal cycle 21. The duration of each of the low voltage periods is much greater than the duration of each of the high voltage periods; the ratio of the durations can be greater than 100.

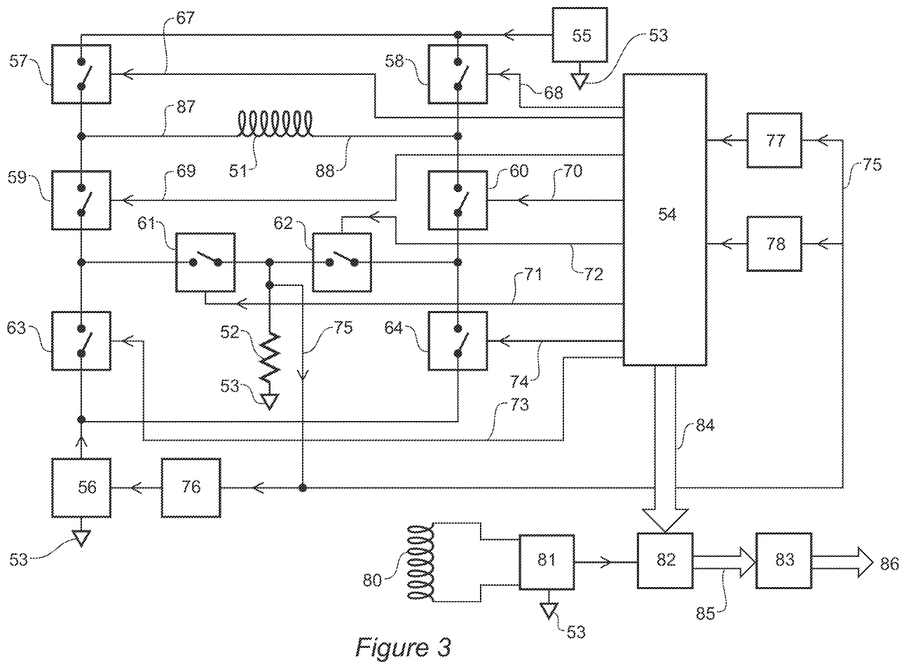

FIG. 3 shows an embodiment of the switching circuit of the transmit electronics 1 (FIG. 1) capable of producing the repeating transmit signal cycle of FIG. 2. In FIG. 3, transmit coil 51 is connected to transmit electronics consisting of elements 52, 53, 54, 55, 56, 57, 58, 59, 60, 61, 62, 63, 64, 67, 68, 69, 70, 71, 72, 73, 74, 75, 76, 77 and 78. A high-voltage power source 55 is connected to one terminal of each of switches 57 and 58 (described herein as “high-side” switches). Another terminal of each of switches 57 and 58 is connected to transmit coil 51 and to switches 59 and 60 (described herein as “low-side” switches) respectively. The first high -voltage power source 55 is connected to the system ground 53.

When closed, switch 61 connects switches 59 and 63 to the system ground 53 via a low-value resistor 52 (e.g. 0.05Ω). When closed, switch 62 connects switches 60 and 64 to the system ground 53 via the low-valued resistor 52. Switches 63 and 64 are connected to a low-voltage power source 56 which is also connected to the system ground 53.

All the switches are controlled to be “on” or “closed” (with very low resistance, e.g. 0.05Ω) or “off” or “open” (effectively open circuit) by timing control electronics 54. Switch 57 is controlled by control line 67, switch 58 via control line 68, switch 59 via control line 69, switch 60 via control line 70, switch 61 via control line 71, switch 62 via control line 72, switch 63 via control line 73, and switch 64 via control line 74.

A high voltage (e.g. +180V) from an output of the high-voltage power source 55 is fed to switches 57 and 58, and a low voltage, in this example a negative voltage (e.g. −1V) from an output of the low-voltage power source 56 is fed to switches 63 and 64. An average value of the high voltage from the high voltage power source is maintained to be constant by electronics within the high-voltage power source.

To produce a repeating transmit signal cycle with its concomitant current, as shown in FIG. 2 (b), the current 92 in the transmit coil 51 during the first high-voltage period 42 (FIG. 2 (c)) increases rapidly in a positive sense. During this first high-voltage period 42, a first high voltage 44 (FIG. 2 (a)) is switched to the transmit coil 51. A first negative feedback loop ensures that the current 92 in the transmit coil 51 changes during the first high-voltage period 42 such that, when the switches switch the first low voltage 45 to the transmit coil 51 during the first low-voltage period 43, the current 93 in the transmit coil 51 remains constant throughout this first low-voltage period 43 because the initial current equals the applied first low voltage 45 divided by a total resistance of the transmit current path which includes the resistance of the transmit coil and the equivalent output resistance of the transmit electronics (including switches, power supply, cables and tracks). After the first low-voltage period 43 with constant current 93, the current 96 in the transmit coil 51 during the second high-voltage period 47 increases rapidly in a negative sense. During this second high-voltage period 47, a second high-voltage 49 is switched to the transmit coil 51. A second negative feedback loop ensures that the change in the current 96 in the transmit coil 51, during the second high-voltage period 47, is such that when the switches switch the second low voltage 50 to the transmit coil during the second low-voltage period 48, the current 97 in the transmit coil 51 during this second low-voltage period 48 remains constant because the value of the current 97 in the transmit coil 51 at the start of the second low-voltage period 48 equals the applied second low voltage 50 divided by a total resistance which includes the resistance of the transmit coil and the equivalent output resistance of the transmit electronics (including switches, power supply, cables and tracks).

A period is considered to be a high-voltage period if the average of said voltage during that period is considered to be high level when compared with voltage levels at some other times of a repeating transmit signal cycle. Similarly, a period is considered to be a low-voltage period if the average of said voltage during that period is considered to be low when compared with voltage levels at some other times of a repeating transmit signal cycle. High voltage and low voltage are relative terms. It is considered that the range of the high voltage for the present invention is 10V to 400V with respective range of low voltage being 0.1V to 15V. For example, in the presence of a period with average voltage of 400V and a period with average voltage of 15V, the period with average voltage of 400V will be considered as the high-voltage period and the period with average voltage of 15V will be considered as a low-voltage period. On the other hand, in the presence of a period with average voltage of 1V and a period with average voltage of 15V, the period with average voltage of 15V will be considered as the high-voltage period and the period with average voltage of 1V will be considered as the low-voltage period.

Accordingly, any high voltage period does not require constant high voltage as long as the average of the voltage during that period is considered to be high level, when compared with voltage levels at other times of a repeating transmit signal cycle. For simplicity, the example illustrated in FIG. 2, described above, demonstrates only a particular embodiment where all high-voltage periods have switched high voltage for their entire durations and all low-voltage periods have switched low voltage for their entire durations.

The output resistance of the transmit electronics during the first low-voltage period 43 is typically slightly different to that of the second low-voltage period 48, owing to different switches and, hence, the voltage across the transmit coil (excluding switching electronics) is typically slightly different, and thus the absolute value of the current in the transmit coil during the first low-voltage period and the second low-voltage period are likewise slightly different, the slight difference not being shown in FIG. 2. The first negative feedback loop might control the duration of the first high-voltage period or the duration of the switched high voltage within the first high-voltage period, and/or the magnitude of the first high voltage 44. The second negative feedback loop might control the duration of the second high-voltage period or the duration of the switched high voltage within the second high-voltage period, and/or the magnitude of second high voltage 49. It is usually simpler to arrange for the control of the durations.

The high-voltage source 55 can consist of a storage capacitor charged by both a switch-mode power supply and the current in the transmit coil. At times other than when it is charging, the transmit coil also discharges the storage capacitor. During the high-voltage periods, the voltage across the capacitor may have a ripple of several percent of its magnitude without causing significant deterioration in performance of the metal detector; this reduces the minimum capacitance required for the storage capacitor. For example, suppose the high voltage is about 180V, the inductance of the transmit coil about 0.25 mH and the current in the transmit coil at the commencement of the first high voltage period about −2 A (charging) and, at termination of the high voltage period, about +2 A (discharging). If the storage capacitor has a capacitance of about 0.47 μf and, assuming that the switch mode power supply supplying the storage capacitor does not charge the storage capacitor significantly during the high-voltage periods, the voltage across the storage capacitor will change by about 6V as the energy from the transmit coil 51 is transferred to and from the storage capacitor during the high-voltage periods. The high-voltage power source 55, consisting of a switch-mode power supply and said storage capacitor, maintains a selected constant average value of the first high voltage and second high voltage which may include a few percent ripple throughout the repeating transmit signal cycle; thus the average first and second high voltages are controlled to be approximately constant.

As shown in FIG. 2, the average voltage switched to the transmit coil is of the same sign for the first high-voltage period 42 and the first low-voltage period 43, which is of opposite sign to the time-average of the voltages switched for both the second high-voltage period 47 and second low-voltage period 48. The table below summarizes the switch combinations in FIG. 3 where S57=switch 57, S58=switch 58 etc. for the high-voltage power source 55 (e.g. +180V) being of opposite polarity to the low-voltage power source 56 (−1V).

| S57 | S58 | S59 | S60 | S61 | S62 | S63 | S64 | Voltage across transmit coil via switches |
|---|---|---|---|---|---|---|---|---|
| on | off | off | on | n/a | on | n/a | off | +first high voltage |
| | | | | | | | | (V at node 87 V at node 88 = +180 V) |
| on | off | off | on | n/a | off | n/a | on | +first high voltage − first low voltage |
| | | | | | | | | (e.g. V at node 87 − V node 88 = +181 V) |
| off | on | on | off | on | n/a | off | n/a | −first high voltage (second high voltage |
| | | | | | | | | with e.g. V at node 87 − V at node |
| | | | | | | | | 88 = −180 V) |
| off | on | on | off | off | n/a | on | n/a | −first high voltage + first low voltage (e.g. |
| | | | | | | | | V at node 87 − V at node 88 = −181 V) |
| off | off | on | on | on | on | off | off | Short circuit |
| off | off | on | on | on | off | off | on | −first low voltage (e.g. V at node 87 − V at |
| | | | | | | | | node 88 = +1 V) |
| off | off | on | on | off | on | on | off | +first low voltage (second low voltage with |
| | | | | | | | | e.g. V at node 87 − V at node 88 = −1 V) |

For simplicity, the table immediately above assumes that the resistances in the transmit electronics and power sources are zero.

If the high-voltage power source (e.g. +180V) and the low-voltage power source (e.g. +1V) are of the same polarity, then the table is as follows:

| S57 | S58 | S59 | S60 | S61 | S62 | S63 | S64 | Voltage across transmit coil via switches |
|---|---|---|---|---|---|---|---|---|
| on | off | off | on | n/a | on | n/a | off | +first high voltage |
| | | | | | | | | (V at node 87 − V at node 88 = +180 V) |
| on | off | off | on | n/a | off | n/a | on | +first high voltage − first low voltage |
| | | | | | | | | (e.g. V at node 87 − V at node 88 = +179 V) |
| off | on | on | off | on | n/a | off | n/a | second high voltage |
| | | | | | | | | (i.e. −first high voltage with V at node 87 − V at |
| | | | | | | | | node 88 = −180 V) |
| off | on | on | off | off | n/a | on | n/a | second high voltage − second low voltage |
| | | | | | | | | (e.g. V at node 87 − V at node 88 = −179 V) |
| off | off | on | on | on | on | off | off | Short circuit |
| off | off | on | on | on | off | off | on | second low voltage (−first low voltage |
| | | | | | | | | (e.g. V at node 87 − V at node 88 = −1 V) |
| off | off | on | on | off | on | on | off | −first low voltage (e.g. nodes 87 − 88 = +1 V) |

In this embodiment, voltages across resistor 52 are proportional to the currents 93, 97 in the transmit coil 51 during the low-voltage periods, except when the transmit coil is short-circuited. The currents 93, 97, can be measured through a voltage, at node 75, with respect to the system ground 53. While a current 93 is in the coil 51 during the first low-voltage period 43, the voltage at node 75 is monitored by an amplifier 77 in a first negative feedback loop. The measurement is then used by the timing control electronics 54 to control one or more parameters of the transmit signal during a high-voltage period within repeating transmit signal cycles subsequent to the specific cycle in which the measurement was taken. Similarly, an amplifier 78 in a second negative feedback loop measures the transmit coil 97 of FIG. 2 (b) during the second low-voltage period 48 in FIG. 2 (c) through the voltage at node 75 and the timing control electronics 54 controls one or more parameters of the transmit signal during a different high-voltage period within repeating transmit signal cycles subsequent to the specific cycle in which the measurement was taken.

During operation of the transmit circuit, the resistances of the various transmit current paths that are connected to the transmit coil 51 can change, for example, due to changes of temperature of components in any of the paths. These changes evolve slowly compared to the rate of repetition of transmit signal cycles. As the resistance of a transmit current path that is active during a low voltage period changes over a series of cycles, the average current during that period will change as that resistance changes, unless steps are taken to correct for the effects of the change in resistance. A third negative feedback loop monitors the currents 93, 97 in the transmit coil 51 for at least part of the first low voltage period 43 and at least part of the second low voltage period 48, and controls the average value of the current in the transmit coil 51 during the first low voltage period 43 to have the same value from cycle to cycle and the average value of the current during the second low voltage period 48 to be of another or the same fixed value and to have this value from cycle to cycle. This third negative feedback loop includes a slow response amplifier 76 that controls the voltage at the output of the low voltage power source 56, e.g. to provide the first low voltage 45 and the second low voltage 50 of FIG. 2(a).

One way of maintaining the average value of the current as the same from cycle to cycle is to have the magnitudes of the currents in low-voltage periods maintained as constant by negative feedback loops within the transmit electronics to equal the current that flows when a low voltage is switched to the transmit coil via the switching electronics at the beginning of a low-voltage period. Hence the transmit coil reactive voltage is constant and equal to zero during low-voltage periods as v=Ldi/dt=0, where v is the transmit coil reactive voltage, i the constant transmit coil current and L the effective inductance of the transmit coil.

There is an advantage in maintaining the value of the average current in each half-cycle as constant from cycle to cycle besides having the current constant within each low-voltage period in a cycle. Assuming that the combinations of the switches in the table are the only combinations selected, that the output impedances of the high-voltage power source 55 and the low-voltage power source 56 are low, that the switches are of low “on” impedance, and the value of resistor 52 is low, then the driving impedance of the transmit electronics to transmit coil 51 is low throughout the whole repeating transmit signal cycle, or at least immediately after very short durations of switching transitions between the various voltages of the various power sources. For example, the durations of the said transitions may be of the order of 10 nanoseconds, whereas the duration of a repeating transmit signal cycle, herein referred to as a fundamental period, may be of the order of a millisecond . A “low” output impedance of the transmit electronics connected to the transmit coil may be considered to be, say, less than three times the equivalent series resistance of the transmit coil, at least during periods when the low-voltage source 56 is switched to the transmit coil in either polarity sense. In particular, the driving impedance of the switching electronics and thus the output impedance of the transmit electronics presented to the transmit coil 51 is low immediately after a short duration of switching transition between the high voltages to the low voltages. During these transitions, which are usually break-before-make for reasons of efficiency and reliability, the impedance is still relatively low because the switches are either in the process of turning on or off, or present a capacitive low impedance given the very short duration switching times involved.

In order to maintain power efficiency, average voltage drops across the resistive components must be kept relatively low. As the high-voltage periods are considerably shorter than the low-voltage periods, the equivalent series resistance of the transmit electronics during the high-voltage periods (e.g. 2Ω) may be substantially higher than the equivalent series resistance of the transmit electronics during the low-voltage periods (e.g. 2Ω) yet still maintaining high power efficiency, assuming the switch mode power supply 55 is efficient. Hence the “low impedance” of the transmit electronics throughout the repeating transmit signal cycle needs to be viewed in this context, and also in the context of having a relatively low value of storage capacitor in the high voltage source 55, as described above.

The receive coil 80 is connected to receive electronics 81, 82, 83, 84, 85, 86. The receive coil receives a receive magnetic field which induces a receive signal in it. The receive signal is fed to the receive electronics 81, 82, 83, 84, 85, 86 that filters and processes the receive signal to produce an indicator output at 86, the indicator output 86 at least indicating the presence of at least some metal targets affected by the transmitted magnetic field. Receive coil 80 is connected to an input amplifier/filter 81, which in turn is connected to sampling circuits or synchronous demodulators 82, and the source of the synchronous demodulator control signals being provided via 84 by the timing control electronics 54. The receive electronics contains yet further signal processing 83 which processes outputs 85 of the synchronous demodulators 82; examples of the processing are described in some of the referenced patents which may be similarly usefully employed in this invention. The receive electronics 82 processes, that is synchronously demodulates or samples, the received signal induced by the receive magnetic field, during at least some of the receive periods, which is approximately free of any reactive X components as the current in the transmit coil is approximately constant. At the time of writing, with switching analogue electronics, it is possible to maintain a reactive voltage of less than the order of 0.01% of the transmit coil applied voltage during receive periods, for transmit currents of the order of Amperes. In particular, the signals from the viscous paramagnetic components of magnetic soils can be cancelled by similar methods to those disclosed in the patents incorporated by reference.

First and second high voltages assist with enhancing receive signals of fast time constant targets and may assist in improving signal-to-noise ratio if the techniques disclosed in U.S. Pat. No. 6,636,044 are employed. A useful absolute value of the first (and second) high voltage is within the range 10V to 400V. For a hand-held metal detector of limited battery capacity, a useful current in the transmit coil is of the order of Amperes, so that with a 1V low-voltage source, the transmit power consumption is of the order of Watts. As the resistance of the transmit coil plus transmit electronics during the low-voltage period is of the order of, say, 0.1Ω to 1Ω, useful absolute voltages of the first and second low voltages are within the range 0.1V to 15V.

The processing of the received signal by the receive electronics includes synchronous demodulation, sometimes known as sampling, followed by averaging and/or low-pass filtering to substantially remove signals of the frequency of the repeating transmit signal cycle, to produce a reactive signal and a resistive signal, the reactive signal responsive to non-dissipative elements within the interrogated region, and the receive resistive signal responsive to dissipative elements within the interrogated region.

As the transmit coil conducts a finite current during the low-voltage periods of zero reactive voltage, the resulting receive signal is composed of purely “resistive” signal (R) components from energy-dissipative components and contains no reactive signal (X) components, but because the coupling between the transmit coil 51 and receive coil 80 varies as the coil is passed by reactive environmental components of such things as magnetic soils, a signal proportional to the time rate of change of coupling of the transmitted magnetic field to the receive coil is induced in the receive electronics and might manifest in the outputs of the synchronous demodulators 85 depending on the choice of synchronous demodulation.

One way to cancel this signal is to have the receive electronics sample a signal derived from a transmission period of non-zero transmit reactive voltage, e.g. the high-voltage periods, then to process the sampled signal such that a linear combination of the result with the sampled resistive signal to cancel the signal proportional to the time rate of change of coupling of the transmitted magnetic field to the receive coil. Thus a synchronous demodulator in 82 is required to measure the signal, during these non-zero transmit reactive voltage periods, to generate a receive reactive signal (X) responsive to the non-dissipative components. This receive reactive signal is demodulated, then differentiated with respect to time to give a differentiated receive reactive signal and a first proportion of the differentiated receive reactive signal needs to be subtracted from a receive resistive signal (R) to give a modified receive resistive signal such that the said first proportion is selected to approximately cancel any components of the receive resistive signal proportional to the differentiated receive reactive signal. The modified receive resistive signal is further processed by the receive electronics in 83 to give an indicator output at 86.

In addition, the synchronous demodulators 82 need to be balanced to cancel the rate of change of static environmental magnetic fields, for example the earth's field and those of magnetised rocks.

The resistances of the switching elements and of the transmit coil are functions of temperature. There are two ways in which signals can be compensated for this. Either the selection of the first proportion of the differentiated receive reactive signal is adjusted if the voltages during the first and second low-voltage periods are fixed, or the values of the low voltages are varied by the slow response third negative feedback amplifier 76 which maintains as constant average current in the transmit coil during each low-voltage period such that the transmitted magnetic field is independent of temperature.

Unlike the invention disclosed in WO/2008/006178, this embodiment described herein is not designed to keep the transmit coil reactive voltage independent of the transmit coil inductance by adjusting the magnitude of the first low voltage in a repeating transmit signal cycle. Rather, the first low voltage is held constant, and with other parameters such as voltages during, and/or durations of, non-zero transmit coil reactive voltage periods are adjusted to maintain constant the current at a fixed value from cycle to cycle in the transmit coil during the first and second low-voltage periods; each low-voltage period can have a different fixed value, but a fixed value for a particular low-voltage period is maintained to be the same form cycle to cycle. Since the current is maintained constant at a fixed value during the first low-voltage period, the average value of the current of the first low-voltage period of a particular cycle is the same as the average value of the current of the first low-voltage period of another cycle. In other words, the present invention maintains the average current of a particular low-voltage period, during which there is zero reactive voltage, to be constant from cycle to cycle. As the invention disclosed in WO/2008/006178 adjusts the magnitude of the first low voltage, the current, though still be constant, would be constant at a different value from cycle to cycle.

The feedback control of the first high-voltage period actively monitors the current during the first low-voltage period and actively controls the voltages during, and/or durations of, the first high voltage period to maintain the average current of the low-voltage period to be constant from cycle to cycle.

During an operation of the metal detector, the inductance of the transmit coil is modulated by the soil. Modulation of the inductance of the transmit coil occurs because the inductance of the transmit coil varies as it is passed over soils, especially magnetically permeable soils, which is fairly common. Once the modulation of inductance of the coil occurs, the magnitude of the current during the low-voltage period will change if the feedback control of the high-voltage period is not implemented.

The table below outlines the differences between this invention and WO 2008/006178 A1.

| | This invention | WO 2008/006178 |
|---|---|---|
| Product of duration and | The product of duration and voltage | There is no provision |
| average absolute voltage of a | is not modulated directly by the | in WO2008/006178 for |
| non-zero reactive voltage | modulation of the inductance of the | control, or change, of |
| period (durations are in the | transmit coil by the permeability of | the product in the |
| order of >0.1 s) | the ground, but is altered by the | non-zero transmit coil |
| | system in response to the | reactive voltage |
| | modulation of the inductance of the | periods. In other |
| | transmit coil. The “times” are an | words, the |
| | indication of the rate at which the | high-voltage applied to |
| | inductance is modulated as the coil | the transmit coil during |
| | is passed over magnetic ground by | the non-zero reactive |
| | an operator. The product can be | voltage period is NOT |
| | changed through altering either or | changed in magnitude |
| | both of the high-voltage applied to | and/or duration; it has |
| | the transmit coil during the | the same value from |
| | non-zero reactive voltage period, | cycle to cycle. |
| | and the duration of that application. | |
| Product of duration and | Independent if average absolute | Independent |
| average absolute voltage of a | transmit current constant, but | |
| non-zero reactive voltage | dependent if applied voltage to | |
| period as a function of | transmit coil during zero reactive | |
| temperature | transmit voltage periods is constant | |
| | and temperature independent | |
| Average absolute transmit | The average of the absolute current | The indirect |
| current ignoring temperature | of each equivalent receive period | modulation is |
| effects (The term “average | that has the same, or constant, | occurring in the same |
| current” means the average | value from cycle to cycle. This is | time scales (>0.1 s) as |
| of the current in a receive | effected, in this invention, by the | the modulation of the |
| period of one particular | modulation of the time-voltage | product of time and |
| cycle) | product in the non-zero transmit | voltage in the first item |
| | coil reactive voltage periods. | of the table. It is the |
| | | average current that is |
| | | being modulated. The |
| | | average current of the |
| | | equivalent receive |
| | | period of each cycle, |
| | | generally, has a |
| | | different value. |
| Average absolute transmit | Dependent if applied voltage to | Independent |
| current as a function of | transmit coil during zero reactive | |
| temperature | transmit voltage periods is | |
| | temperature independent, else | |
| | independent if average absolute | |
| | transmit current constant | |
| Applied voltage to transmit | Constant. The principle of | Modulated by |
| coil during zero reactive | operation requires no provision for | magnetic soils in |
| transmit voltage periods | variation of the low voltage applied | response to modulation |
| ignoring temperature effects | to the coil during receive periods. | of the inductance of the |
| (times of the order of >0.1 s) | More complex embodiments that | transmit coil |
| | take account of small, slow changes | |
| | in circuit resistance as its | |
| | temperature changes can vary the | |
| | applied low voltage. | |
| Applied voltage to transmit | Effectively constant (may change | Constant within the |
| coil during one or more zero | by an extremely small amount as a | receive period of a |
| reactive transmit voltage | function of temperature) | particular cycle if |
| periods during a specific | | sample-and-hold |
| cycle (of the order of | | electronics employed |
| transmit fundamental period, | | to ensure this. |
| e.g. ms) | | However, the applied |
| | | voltage changes from |
| | | cycle to cycle. |
| Applied voltage to transmit | Dependent if average absolute | Dependent |
| coil during zero reactive | transmit current constant, but | |
| transmit voltage periods as a | independent if applied voltage to | |
| function of temperature | transmit coil during zero reactive | |
| (times of the order of >0.1 s) | transmit voltage periods is constant. | |

In this table, the references to “times of the order of >0.1 s” assumes that soil magnetic permeability may change significantly over periods of this order as the transmit coil traverses such soils, but does not change significantly during periods substantially shorter than 0.1 s.

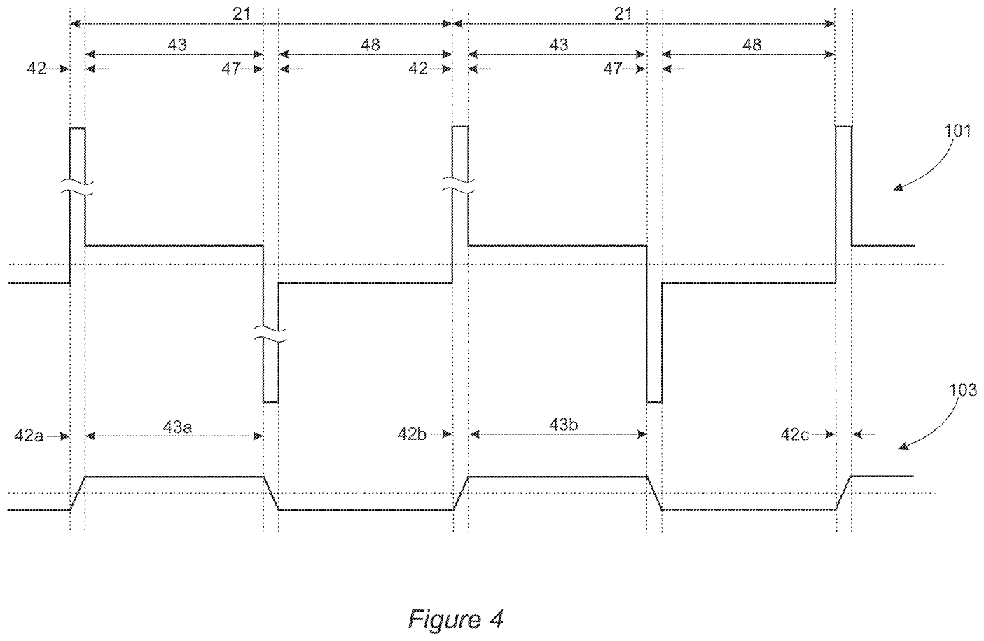

FIG. 4 depicts a repeating transmit signal cycle designed to facilitate the explanation of the function of maintaining average current constant over series of consecutive transmit cycles.

As explained previously, the term “period” means a duration of time, and “cycle” means a series of “periods” that are regularly repeated in the same order. With reference to FIG. 4, the shown repeating transmit signal cycle 101 consists of repeating cycles of positive high-voltage period 42, positive low-voltage period 43, negative high-voltage period 47 and negative low-voltage period 48, all applied to a transmit coil. Trace 103 shows the corresponding current in the transmit coil. Each label 42a, 42b, 42c etc. represents a particular positive high-voltage period of the repeating positive high-voltage period 42. The same system is applied for all the numerals in this figure. The repeating periods from cycle to cycle are not identical unless controlled to be so. In fact, the durations of certain periods are adjusted, and/or the voltage level within those certain periods are adjusted, as part of the feedback control scheme of the present invention. The adjustment made, for example during a high-voltage period, changes the voltage only slightly, and the resultant voltage will still be considered as a high voltage when compared to the voltage during a low-voltage period.

What is meant by ‘maintains the average current of a receive period as constant’ is that the value of the average of the current during a receive period is the same from cycle to cycle The present invention maintains the average current of a receive period as constant. The receive period occurs during the positive low-voltage period 43 and the negative low-voltage period 48, or both.

Referring to FIG. 4, if a receive period occurs during the positive low-voltage period 43, the current during this period 43 is maintained as constant, and the current is monitored using a feedback system. During operation of a detector, the inductance of the coil of the detector is modulated by the soil. Without any feedback control, the current would not be able to be maintained constant. The present invention controls the duration of the high-voltage period before the low-voltage period and/or the voltage applied to the coil during high-voltage period so that at the beginning of the low-voltage period, the current value is of a fixed value from cycle to cycle and, in effect, the average value of the current during the low-voltage period is maintained to be constant from cycle to cycle. For example, the magnitude of a voltage and/or duration of positive high-voltage period 42a is adjusted to maintain the current during positive low-voltage period 43a to be constant and of a particular value; the magnitude of a voltage and/or duration of positive high-voltage period 42b is adjusted to maintain the current during positive-low-voltage period 43b to be constant and of a particular value. The adjustment is made possible by measurement of the current in the transmit coil during the positive low-voltage period. For example, the current of 43a is measured and if found to differ from the intended fixed value, the magnitude of a voltage and/or duration of positive high-voltage period 42b is adjusted to maintain the current during positive low-voltage period 43b to be constant and of a particular value. By doing so the average value of the current during the positive low-voltage periods 43 are maintained to be constant. Of course, maintained to be constant does not mean “constant” all the time. When coil movement relative to the soil modulates the inductance of the coil, its current changes infinitesimally even during a single “constant current” period, but one skilled in the art would still consider the said period to be of constant current because it closely approximates a constant current period. Further, all feedback loops have a delay thus an off current value during a low-voltage period in a cycle will be rectified by the feedback control system in the next cycle.

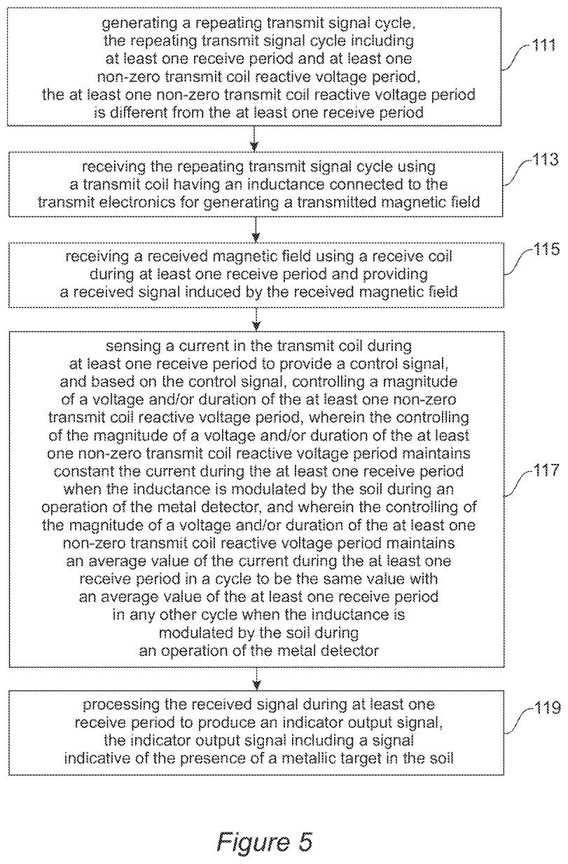

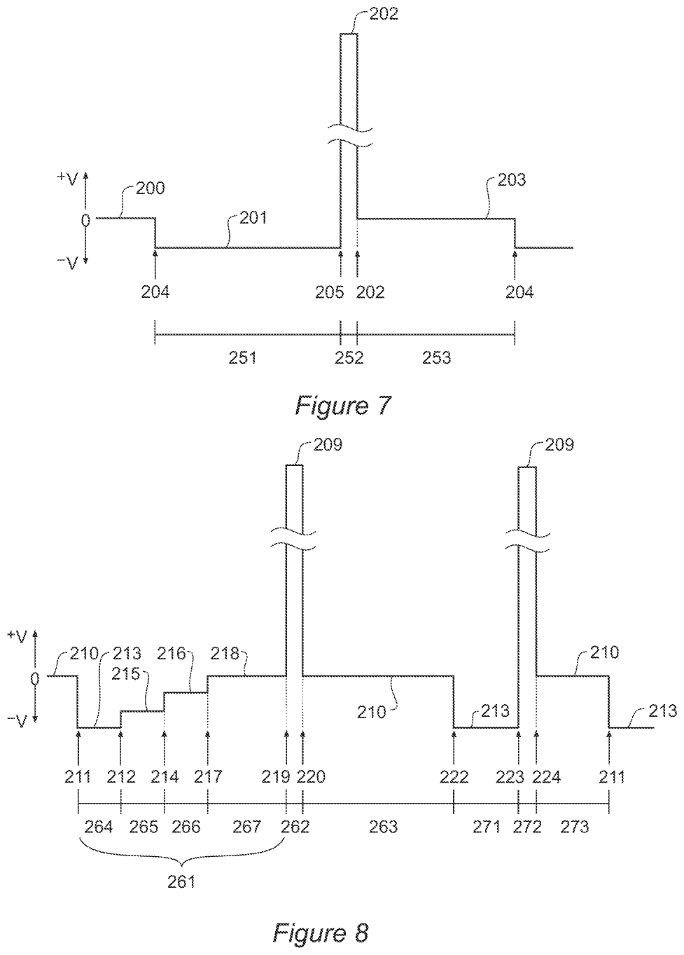

FIG. 5 summarises steps of the present invention. The first step 111 involves generating a repeating transmit signal cycle, the repeating transmit signal cycle including at least one receive period and at least one non-zero transmit coil reactive voltage period, the at least one non-zero transmit coil reactive voltage period is different from the at least one receive period. An example of the repeating transmit signal cycle is shown in FIG. 4, which consists of the repeating cycle of positive high-voltage period, positive low-voltage period, negative high-voltage period and negative low-voltage period. In this example, the receive period occurs during the first positive low-voltage period, and the positive high-voltage period is the non-zero transmit coil reactive voltage period. The average value of the transmit current during each receive period has an average value that is maintained from cycle to cycle. While it is possible for two or more such receive periods to have the same value of average current, it is not generally so. Another example of the repeating transmit signal cycle can be found in FIG. 7. In the broadest form, only a period with changing current (non-zero transmit coil reactive voltage period) and a receive period are required. The intended receive period would be a period of zero transmit coil reactive voltage as will be apparent in relation to step 117.

The next step 113 includes receiving the repeating transmit signal cycle using a transmit coil having an inductance connected to the transmit electronics for generating a transmitted magnetic field.

Step 113 is followed by step 115 which involves receiving a received magnetic field using a receive coil during at least one receive period and providing a received signal induced by the received magnetic field.

The next step 117 involves feedback controls. Firstly, the processing unit senses a current in the transmit coil during at least one receive period to provide a control signal. The sensing of the current may include one or more of, measuring the magnitude of the current, calculating the average current value for the current measured over a receive period, measuring the changes of the current relative to a reference value etc.

Based on the control signal, the processing unit then controls a magnitude of a voltage during and/or duration of the at least one non-zero transmit coil reactive voltage period. In particular, when the inductance of the transmit coil is modulated by the soil during an operation of the metal detector, the step of controlling a magnitude of a voltage and/or duration of the at least one non-zero transmit coil reactive voltage period includes changing the magnitude of a voltage and/or duration of the at least one non zero transmit coil reactive voltage period to maintain an average value of the current during at least one receive period in a cycle to be substantially the same value (within 1 mA) as an average value of the current during at least one receive period in any other cycle. The magnitude of a voltage and/or duration of the at least one received period is maintained to be substantially the same from cycle to cycle when the one or more negative feedback loops change the magnitude of a voltage and/or duration of the at least one non zero transmit coil reactive voltage period.

While not shown in FIG. 5, when the inductance of the transmit coil is modulated by the soil during an operation of the metal detector, the one or more negative feedback loops may also maintain constant the current during the at least one receive period.

Finally, at step 119, the received signal is processed during at least one receive period to produce an indicator output signal, the indicator output signal including a signal indicative of the presence of a metallic target in the soil.

The steps summarised in FIG. 5 can be programmed and stored in a computer-readable medium. These steps can then be used by a metal detector to control the functionality of a transmitter, receiver, and signal processing unit.

To compare the present invention to a conventional pulse induction detector, assume that:

In both detectors, only transmit coil losses are taken into account. These losses are normalised to be the same in both cases, with ideal lossless electronics and with the time constant of the transmit coil plus transmit electronics effectively infinite, for simplicity. However, for the purposes of calculating the power consumption of the transmit electronics, assume a very small effective series resistance in the transmit coil. The synchronous demodulator outputs are normalised to wideband input white noise, and the electronic bandwidths of the detectors are assumed to be the.

The repeating transmit signal cycle of a pulse induction system includes a low-voltage period followed by a back-emf high-voltage period which is, in turn, followed by a zero transmit current period. In the case of a pulse induction system, a voltage of −1 voltage units is applied to the transmit coil for the low-voltage period of duration 1 time unit, and the duration of the back-emf high-voltage period is very short compared to that, so effectively zero for purposes of explanation of the principle. The receive electronics synchronously demodulates with a gain of +1 during the following zero transmit current period of ½ time unit then, following this, the receive electronics synchronous demodulates with a gain of −1 for a further zero transmit current period of ½ time unit. Hence, the repeating transmit signal cycle of a pulse induction system has a duration of 2 time units.

In this embodiment of the invention, the repeating transmit signal cycle shown in FIG. 2 has a duration of 2 time units. The receive electronics synchronously demodulates with a gain of +1 for the first low-voltage period and a gain of −1 for the second low-voltage period. For this comparison, the high-voltage periods are regarded as having durations of zero time units.

If there is a first order target of time constant τ=L/r (where L is the effective first order inductance, and r is the effective resistance), where τ>>1, the ratio of the demodulated signal produced by the receive electronics of an embodiment as described above and the pulse induction system as described above, the ratio of the demodulated signals asymptotically approaches

16τ/\sqrt{3} (2)

Hence, for long time constant targets, the demodulated signal from the described embodiment of this invention is substantially larger than that from an “equivalent” pulse induction system, as discussed in general terms above.

The inductance of the transmit coil is modulated by the magnetic susceptibility of magnetically mineralised soils as the transmit coil is moved over such soils. In order to compensate for the modulations of the values of the average currents in the low-voltage periods that this would produce from one cycle to the next, the feedback loops modulate either the durations of the first and second high-voltage periods, or the magnitudes of the high voltages applied to the transmit coil during the high-voltage periods, or both.

Firstly, consider the embodiment wherein the feedback loops vary the durations of the high-voltage periods in order to compensate for the changes in the rate of change of current in the transmit coil during high-voltage periods, the changes of rate being brought about by the modulation of the inductance of the transmit coil as it is moved over magnetically permeable ground. Variations in the rate of current change during the high-voltage perdiods affect the receive signal slightly, in particular the response from viscous superparamagnetic soil components which need to be accurately cancelled, as disclosed in the patents incorporated by reference.

The receive signal from viscous superparamagnetic soil components for an approximate current square-wave during the first low-voltage period is proportional to

$${\sum }_{n = 0}^{∞} {( - 1 )}^{i} ( \frac{ln \{ \frac{t + {nT}_{lv} + {T}_{hv}}{t + {nT}_{lv}} \}}{{T}_{hv}} ) \qquad ( 3 )$$

where T₁ᵥ is the duration of the low-voltage periods, Tₕᵥ is the duration of high-voltage periods, and Tₕᵥ<<T₁ᵥ. If the inductance of the transmit coil increases by xL, where L is the original inductance, while passing the coil over magnetically permeable soils (typically x<0.01 in most highly magnetically permeable gold field soils), the transmit electronics causes Tₕᵥ to increase, likewise, by xTₕᵥ. Only the first term in (3) is significantly affected, namely

$$\frac{ln \{ \frac{t + {T}_{hv}}{t} \}}{{T}_{hv}} \qquad ( 4 )$$

In terms of cancellation of viscous superparamagnetic soil components, the shape of the decay changes by ln[t+(1+x)Tₕᵥ] rather than ln[t+Tₕᵥ], assuming the high voltages are held constant from cycle to cycle (for example periods 42 and 47 in FIG. 2).

As sampling or synchronous demodulation commences, after the cessation of the high-voltage period, at times several times the duration of Tₕᵥ, e.g. say 2 times minimum, ln[t+(1+x)Tₕᵥ] commences at a minimum of ln[2Tₕᵥ+(1+x)Tₕᵥ] or ln[3Tₕᵥ+xTₕᵥ].

As the maximum change in inductance of the Tx coil is about 1%, [3Tₕᵥ+xTₕᵥ] is, at maximum, approximately 0.3% more than 3Tₕᵥ. Assuming that the receive signal is an accumulation (by integration or averaging) of signals with t>>3Tₕᵥ, this error is very small and does not adversely affect performance in practice.

Alternatively, the negative feedback loops may control output voltages of power source/s.

Several different voltages, possibly including zero volts, from additional power sources of various output voltages may be switched to the transmit coil for various durations within each of the first and second low-voltage periods, and first and second high-voltage periods. Some of the associated periods may be associated with zero transmit coil reactive voltage, and others with non-zero reactive voltage. To take advantage of pulse induction theory, the average voltage applied across the transmit coil during a high-voltage period should be about at least three times greater (e.g. 20 times in the case of pulse induction) in magnitude than the average voltage applied across the transmit coil during a low-voltage period. Each different period of zero reactive transmit coil voltage within the repeating transmit signal cycle requires an associated negative feedback loop to obtain high accuracy in maintaining constant current to avoid any X contamination in the receive signal.

Whilst the waveform in FIG. 2 shows just two different low voltages and two different high voltages switched to the transmit coil, the power sources may provide other voltage outputs, and further switches controlled by timing electronics 54 may switch these to the transmit coil.

Regardless of the different voltages switched to the transmit coil, the average voltage value across the transmit coil in the first high-voltage period is opposite in polarity to the average voltage value across the transmit coil in the second high-voltage period, and the average voltage in the first low-voltage period across the transmit coil is opposite in polarity to the average voltage across the transmit coil in the second low-voltage period.

As the transmit coil is always connected to sources of low-impedance, there is no damped back-emf transmit coil decay signal as there is in pulse-induction metal detectors. The decaying signal of the transmit cycle in pulse-induction detectors places a limit on their ability to detect targets predominantly having fast time constants, such as small gold nuggets, without the problems of reactive signal (X) contamination. In this embodiment, due to the absence of a damped transmit decay signal, receive demodulation can occur with less delay following high-voltage periods than in PI detectors of current art, with less contamination of the resistive receive signal by reactive signal components, improving the capability of detecting targets of fast time constant.

In another embodiment of the repeating transmit signal cycle, the repeating transmit signal cycle includes a low-voltage period (“an energising period”), the low-voltage period being followed by a high-voltage period (“a back-emf period”), and the high-voltage period followed by a zero-voltage period; the zero-voltage period being the said receive period, and the average value of the transmit coil current during the zero-voltage period of every repeating transmit signal cycle is zero. An example voltage waveform of this embodiment is shown in FIG. 7.

Although this embodiment of the repeating transmit signal cycle is that of a PI detector, the waveform of the applied voltage and operation is significantly different from conventional art for the reason explained below.

In a simple form, the transient output from a conventional pulse induction receive coil, in the ideal case of zero capacitive coupling but finite mutual inductance between the transmit and receive coils, is of the form (1) as discussed before.

The transient output from the receive coil of the present invention, in the ideal case of zero capacitive coupling but finite mutual inductance between the transmit and receive coils, is of the form

k(1+ωt)e^{-t} (5)

where transmitted back-emf “instantaneously” terminates at close to zero voltage, so that the voltage of the back-emf period Vo immediately before t=0 becomes approximately zero at t=0.

This is because, in this embodiment of the present invention, the transmit coil is driven at low impedance throughout the repeating transmit signal cycle without any damped decays immediately after the transition between the high-voltage period and the zero-voltage period. Given that the critically damped time constant of the transmit coil, including associated transmit circuitry, is usually significantly longer (e.g. 50%) than that of the receive coil, (5) has an even faster decay than the ratio of (1) and (5) would imply.

Increased power efficiency and reduced delay between the back-emf and receive sampling or synchronous demodulation is possible by driving the transmit coil with a low impedance during the whole transmit cycle, in a manner similar to that disclosed in US 2008/0048661, incorporated by reference, but with control to ensure minimal transmit current during the receive period, and also without high attenuation of long time constant target signals which is the case in US 2008/0048661.

By way of comparison, suppose a system conforming to the teaching of US 2008/0048661 consists of a positive high-voltage period of duration A and of voltage V, followed by a transmit low-voltage period of duration T with −2U volts applied to the transmit coil, then followed by a “back-emf” high-voltage period of duration A and of voltage V, such that for ideal electronics (no power dissipation etc), VA=UT. For simplicity of understanding, let T=VA=1. At the end of the “back-emf” high-voltage period, the transmit current is zero and zero volts is applied across the transmit coil for the zero-voltage period of duration T, whereafter the cycle repeats.

During this zero-voltage period, the signal from a first-order metal target of time constant τ=l/r where l is the effective first order inductance, and r the effective resistance, is proportional to

Ue^{-t/τ}/τ[1+e^{-1/τ}−2τ(1−e^{-l/τ})]/(1−e^{-2/τ}) (6)

assuming that A<<T and of negligible duration.

An “equivalent” pulse induction system with ideal electronics, would have, for example, a repeating transmit signal cycle consisting of an low-voltage period of duration T (with −U applied to the transmit coil so that the power dissipated in the coil is the same as the above for a real situation for a fair comparison), a “back-emf” high-voltage period of voltage V for a period A, such that VA=UT and T−VA=1, and a zero-voltage period of duration T following the “back-emf” high-voltage period, whereafter the cycle repeats. If the “back-emf” period is very short and the transmit coil current is zero during the zero-voltage period, and the signal from a first order metal target during the zero-voltage period is proportional to

Ue^{-t/τ}/τ[1−τ(1−e^{-1/τ})]/(1−e^{-2/τ}). (7)

If τ>>T, that is τ>>1, then the signal from (7) is 3τ times larger than that from (6) during the zero-voltage period.

Hence, for long time constant targets, the signal for the pulse induction system, and that includes the arrangement disclosed in this specification, is larger than that disclosed in US 2008/0048661.

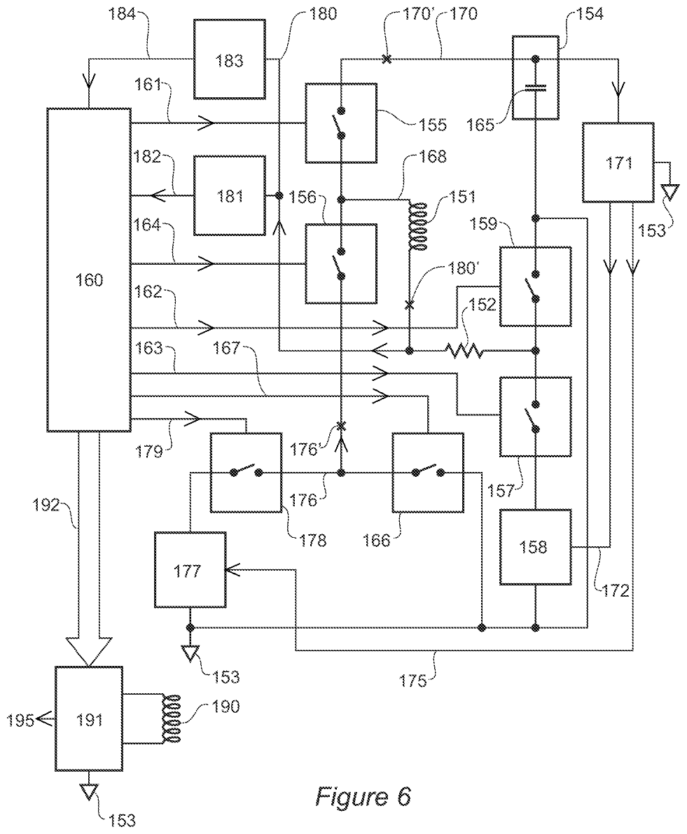

FIG. 6 shows an embodiment of the switching circuit of the transmit electronics capable of producing repeating transmit signal cycle of FIG. 7, which are pulse induction-like waveforms from the low impedance repeating transmit signal cycle source. The transmit electronics consists of all the elements except 151, 190, 191, 192 and 195. The transmit electronics transmits a repeating transmit signal cycle across a transmit coil 151 in series with resistor 152. The resulting current in the transmit coil 151, which produces an alternating magnetic field, may be measured at 180 as a voltage across resistor 152.

Switching electronics consisting of a plurality of switches within the transmit electronics is connected across the series transmit coil 151 and resistor 152 to connect various power sources 154, 158, and 177 to the transmit coil 151 or to short circuit the transmit coil.

Switch 155 and 159 can switch the transmit coil 151 to a first power source 154 which produces a first voltage (e.g. +180V) at its output 170 relative to the system ground 153. A useful absolute value of the first voltage is within the range 10V to 400V.

Switch 166 can switch the transmit coil 151 via switch 156 and 159 to the system ground 153 via resistor 152. Switch 178 can switch the transmit coil 151 via switch 156 and 159 to a second power sources 177. A useful absolute voltage of the second voltage is within the range 0.1V to 15V, e.g. −15V.

The transmit coil 151 is connected to switches 159 and 157 via series resistor 152. Switch 159 connects resistor 152 (and thus transmit coil 151) to the system ground 153 when “on”, and switch 157 connects resistor 152 (and thus transmit coil 151) to a third power source 158 when “on.” The third power source 158 produces at least effectively one different voltage other than zero voltage, the first voltage or second voltage (e.g. +5V). A useful absolute voltage of the third voltage is within the range 0.1V to 15V.

Switches 155, 156, 157, 159, 166 and 178 are controlled to be either “on” (e.g. 0.1Ω) or “off” by timing electronics 160. For example, switch 155 via control line 161, switch 156 via control line 164, switch 159 via control line 162, switch 157 via control line 163, switch 166 via control line 167, and switch 178 via control line 179.

The below summarizes the switch combinations where S151=switch 151, S152=switch 152 etc.

| | | | | | | Voltage across transmit |
|---|---|---|---|---|---|---|
| S155 | S156 | S157 | S159 | S166 | S178 | coil 151 and resistor 152 |
| on | off | on | off | n/a | n/a | first − third |
| on | off | off | on | n/a | n/a | first |
| off | on | on | off | on | off | −third |
| off | on | on | off | off | on | second − third |
| off | on | off | on | on | off | short |
| off | on | off | on | off | on | second |

The table immediately above assumes that both the first power source and second power source are of opposite polarity to the third power source. If this is the case with the first voltage being say 180V, the third voltage being say +5V, and the second voltage say −10V, then the low voltages that may be applied to the transmit coil where a “positive” polarity sense is with switch 155 and 156 end 168 of the transmit coil 151 being positive relative to the resistor 152 end of the transmit coil 151, are 0V (S156=on, S159=on, S166=on, others off), −5V (S156=on, S157=on, S166=on, others off), −10V (S156=on, S178=on, S159=on, others off), −15V (S156=on, S157=on, S178=on, others off). To avoid short-circuiting power sources, either switch 155 is closed (“on”) or switch 156 closed, and either switch 166 is closed or switch 178 closed, and either switch 159 is closed or switch 157 is closed. If the third voltage is say −5V, and the second voltage −10V, then the low voltages that may be applied to the transmit coil are +5V, 0V, −5V, and −10V and so on.

Assuming that only the combinations of the switches in the table are selected, and the output impedances of the first power source 154, the second power source 158, and the third power source 177 are low, and the switches have low “on” impedance when closed, and the value of resistor 152 is low (e.g. 0.05Ω), then the driving impedance of the transmit electronics to transmit coil 151 is low throughout the whole repeating transmit signal cycle or sets of repeating sequences within a repeating transmit signal cycle provided to the transmit coil or at least immediately after very short duration switching transitions between the various voltages of the various power sources. For example, the duration the said transitions may be of the order of 10 ms, whereas the repeating transmit signal cycle fundamental period may be of the order of ms. A “low” output impedance of the transmit electronics connected to the transmit coil may be considered to be, say, less than three times the equivalent series resistance of the transmit coil, at least during the zero transmit period. In particular, the driving impedance of the switching electronics, and thus the transmit electronics to transmit coil 151, is low immediately after a short duration switching transition between the first voltage to zero voltage. During these transitions, which are usually break-before-make for efficiency and reliability reasons, the impedance is still relatively low because the switches are either in the process of turning on or off, or present a capacitive low impedance given the switching times involved. However, even though this said capacitive impedance may not be as low as the “on” resistance of the switches plus output impedance of the power sources, the times involved are so relatively short that effectively it could be said that the output impedance is low even including the transitions.

Receive coil 190 is connected to receive electronics 191, adapted and arranged to receive and process a received magnetic field to produce an indicator output at 195, the indicator output at least indicating the presence of at least some metal targets under the influence of the alternating transmitted magnetic field. Transmit coil 151 and receive coil 190 may be the same coil. The receive electronics contains signal processing, usually including sampling or synchronous demodulation, for example as described in some of the patents incorporated by reference, and the source of synchronous demodulation signals being provided via 192 from the timing electronics 160.

A second negative feedback loop is set up around the path including the voltage at 180 across resistor 152 being fed to an input of an amplifier 181 which includes components to set the stability of negative feedback, an output 182 of the amplifier 181 controlling the duration of a period of a switch set within the timing electronics 160, such as, for example the duration of an low-voltage period commencing at time 204 and terminating at time 205, as depicted in FIG. 7, for which switch 178 connects the transmit coil 151 to the second power source 177. The control of this period within a transmit low-voltage period, high-voltage period, zero-voltage period sequence affects the transmit coil current throughout the said sequence, but this effect ceases during a zero-voltage period if zero volts is applied across the transmit coil and transmit coil current is zero. Sampling the transmit coil current during a zero-voltage period, when switch 156, switch 159 and switch 166 are closed to short circuit the transmit coil 151 (in series with resistor 152) will cause the second negative feedback loop to maintain a value of the transmit coil current during the said sampling period, such as zero current, assuming that the voltage of the first power source 154, and the second power source 177 and the duration of the high-voltage period are of fixed value. In FIG. 6 when switch 159 is closed, the voltage at the node 180 of coil 151 and resistor 152 relative to the system ground 153 equals the transmit coil current multiplied by the total resistance of resistor 152 plus switch 159 (plus circuit board tracks), assuming that the negative feedback loop input impedance is relatively very high.

In FIG. 6, the said first power source 154 is shown as a first capacitor 165. Switch-mode power supply 171 converts energy from the first power source 154 to supply the second power source 177 via line 175, but this can also supply the third power source 158 via line 172.

Another negative feedback loop, a first negative feedback control electronics contained within switch-mode power supply 171, is responsive to the first voltage at 170 and controls the amount of energy converted from the first power source 154 back to second power source 177 (and/or the third power sources 158) so as to maintain the first voltage to be approximately a selected average constant value.

It is not necessary for the first capacitor 165 to be high in value so that, during the high-voltage period, the voltage across the first capacitor 165 is effectively constant as current flows into the capacitor. This voltage may change by several percent without causing significant deterioration in performance. For example, suppose the first voltage at 170 is about 180V, the transmit coil 151 inductance say 0.25 mH and the transmit coil current at the commencement of the high-voltage period is say 3 A, and the first capacitor 165 say 1 μF, and assuming that the switch mode power supply 171 does not discharge the first capacitor 165 significantly during of the high-voltage period, then the voltage across the first capacitor will increase by about 6V as the energy from the transmit coil 151 is transferred to the first capacitor 165 during the high-voltage period. Hence, the switch mode power supply 171 maintains the first voltage to be approximately a selected constant average value which may include several percent ripple throughout the repeating transmit signal cycle.

A high first voltage assists with enhanced receive signals of fast time constant targets, and may improve signal-to-noise ratio if the techniques disclosed in U.S. Pat. No. 6,636,044 are employed.

In order to maintain power efficiency, average voltage drops across the resistive components can be kept low relative to the average transmit coil reactive voltage during the low-voltage period and high-voltage period. As the transmit coil reactive voltage is typically considerably higher during the high-voltage period (e.g. 180V) than the low-voltage period (e.g. 10V), this means that the equivalent series resistance of the transmit electronics during the high-voltage period (e.g. 2Ω) may be substantially higher than the equivalent series resistance of the transmit electronics during the low-voltage period (e.g. 0.25Ω) whilst maintaining high power efficiency, assuming switch mode power supply 171 is efficient. Hence the “low impedance” of the transmit electronics throughout the repeating transmit signal cycle needs to be viewed in this context.

Waveform FIG. 7 depicts a zero-voltage period 253 when the transmit coil 151 (in series with resistor 152) is shorted, and shown as being zero volts 203. At the end of that period a negative voltage 201 (e.g. −5V) from the second power source is applied across the transmit coil during a low-voltage period (period 251) commencing at time 204 and terminating at time 205, and the transmit coil current increases “negatively.” At time 205, the transmit coil is switched to a first power source 154 for a short duration high-voltage period (period 252). During this high-voltage period, commencing at time 205 and terminating at time 202, the transmit current is rapidly reduced in magnitude because the first voltage at 170 is high and positive. Following this short high-voltage period, the repeating transmit signal cycle, commencing at time 202 is repeated, commencing with another zero-voltage period 253 again.

Changes in any voltage or any period (except the zero-voltage period if the transmit current is zero) will cause a change in transmit current throughout the cycle, so the negative feedback loop may change any of these variables to set transmit current to zero during the zero-voltage period. It is easiest to change a period, such as the low-voltage or high-voltage period, rather than a voltage but this alternative is not excluded from this disclosure.

A negative feedback loop may measure the transmit current during the zero-voltage period 253 and control the switching time 204, that is the duration of the low-voltage period 251, or switching time 205, that is the duration of the high-voltage period 252 and low-voltage period 251, so as to maintain zero transmit current during the zero-voltage period 253.

Switch 156 and switch 155 can withstand the voltage of the first power source 154, (e.g. say 200V devices), whereas switches 157, 159, 166 and 178 can withstand the voltages of the second 177 and third power source 158 (e.g. say 30V devices).

To illustrate the current in the system, suppose all elements are ideal (e.g. the transmit coil is a pure superconductor inductor of inductance L with zero series resistance, the power sources have zero output impedance, switches are either zero ohm (on) or infinite (off) etc.). The high-voltage period of duration P1 of first voltage V1 is followed by a zero-voltage period of which is followed by low-voltage period of duration P2 and second voltage V2, then the cycle repeats with a high-voltage period again.

If the transmit coil current during zero-voltage period is zero, then it is zero when low-voltage period commences. At the end of the low-voltage period and thus beginning of the high-voltage period, the transmit coil current is P2V2/L. At the end of the high-voltage period, the transmit coil current is P2V2/L−P1V1/L. Hence the transmit coil current is zero during the zero-voltage period if P1V1=P2V2, and thus each of P1, P2, V1 and V2 will affect the transmit coil current during the zero-voltage period. Thus, a negative feedback loop monitoring the transmit coil current during the zero-voltage period can feedback a signal to control either P1, P2, V1 or V2, or a combination of them, to maintain the transmit coil current at zero during the zero-voltage period.

The receive electronics 191 receives and processes a magnetic field, during at least some of the zero-voltage period 253, to produce an indicator signal indicating the presence of a metal within the magnetic field generated by the transmit coil, the indicator signal being free of reactive signal X because of the zero transmit reactive signal, and because of sufficient delay following the transition between the high-voltage period and zero-voltage period for the value of (5) to become insignificant.

FIG. 8 shows another exemplary form of the repeating transmit signal cycle. It depicts a multi-period multi-voltage waveform which includes two versions of the type of waveform described in relation to the waveform depicted in FIG. 7. The first such version is depicted as low-voltage period 271, high-voltage period 272 and zero-voltage period 273, they corresponding closely to the low-voltage period 251, high-voltage period 252 and zero-voltage period 253 of FIG. 7.

The second version is depicted as low-voltage period 261, high-voltage period 262 and zero-voltage period 263. Although it is not as obvious, the principles are the same and the additional waveform voltages during low-voltage period 261, namely periods 264, 265, 266 and 267, can have advantageous effects, namely increasing the current initially relatively rapidly, then maintaining the transmit coil current at a more or less constant value. This assists with the detection of long time-constant targets whilst maintaining a relatively short fundamental period.

To generate such a waveform as depicted in FIG. 8, the transmit coil is short circuited at time 220 for a zero-voltage period 263, which commences at time 220 and terminates at time 222. At time 222, a negative voltage 213 (e.g. −15V), being a third voltage (say +5V) from the third power source 158 subtracted from a second voltage (say −10V) from second power source 177, is applied across the transmit coil during an low-voltage period 271 commencing at time 222 and terminating at time 223. During this low-voltage period 271, switches 156, 178 and 157 are “on” and all other switches “off”, and transmit current increases “negatively” and moderately rapidly. At time 223, the transmit coil is switched to the first power source 154 of first voltage 209 for a short duration, a high-voltage period 272, commencing at time 223 and terminating at time 224. As this voltage is high and positive, the transmit current rapidly decreases in magnitude. Following this high-voltage period 272 is a zero-voltage period 273, during which the transmit coil 151 (in series with resistor 152) is short-circuited with switches 156, 159 and 166 “on” and all other switches “off.” At time 211, a low-voltage period 261 of periods 264, 265, 266 and 267 commences. At time 211, a negative voltage 213 (e.g. −15V) is again switched across the transmit coil for a period 264 commencing at time 211 and terminating at time 212, and the transmit current increases “negatively” and moderately rapidly.

At time 212, the transmit coil is switched just to the second power source 177, to a lower negative voltage 215 (−10V) than that applied during the period 264, for a period 265 commencing at time 212 and terminating at time 214. As the applied voltage is lower, the transmit current increases more gradually “negatively.” At time 214, the transmit coil is switched just to the third power source 158 to a lower negative voltage 216 (−5V) than that applied during the period 264 or period 265, for a period 266 commencing at time 214 and terminating at time 217. As the applied voltage is lower still, the transmit coil current increases even more gradually “negatively.” At time 217, the transmit coil 151 (in series with resistor 152) is shorted during a period 267 commencing at time 217 and terminating at time 219 and shown as zero volts 218.

During this period 267 switches 156, 159 and switch 166 are “on” and all other switches are “off” and the transmit current decays according to the transmit coil circuit time constant which includes the switching electronics output impedance (e.g. a total series effective resistance of say 0.5Ω for say L=0.25 mH transmit coil; that is a 0.5 ms time constant). Hence the reactive voltage across the transmit coil (−Ldi/dt) is non-zero but small.

This time constant varies slightly during the whole cycle as the switching electronics presents different output impedances owing to different switches and power source impedances.

At time 219, the transmit coil is switched to the first power source 154 of a first voltage 209 for another short duration, a high-voltage period 262 commencing at time 219 and terminating at time 220. As the first voltage is high and positive, so the transmit current rapidly decreases in magnitude. During this period 262, switches 155 and 159 are closed (ie “on”) and switch 156 open (ie “off”). Following this short high-voltage period, the cycle repeats to form a repeating transmit signal cycle.

A fundamental period of the repeating transmit signal cycle in this embodiment may include both identical and different sequences of low-voltage period, immediately followed by a high-voltage period, immediately followed by a zero-voltage period. At least one different negative feedback control electronics is to provide for each different sequence of low-voltage period, immediately followed by a high-voltage period, in turn immediately followed by a zero-voltage period within the fundamental repeating transmit signal cycle, during which the receive electronics receives and processes a magnetic field within the zero-voltage period, to maintain zero transmit coil current during the zero-voltage periods, in addition to the negative feedback loop within the switch-mode power supply 171.

Each different negative feedback control electronics senses the transmit coil current during a zero-voltage period, and provides a control signal to control the duration or magnitude of one or more switched voltages within the immediately preceding low-voltage period and/or high-voltage period, such that the transmit coil current during the zero-voltage period is maintained to be substantially zero.

Hence, for a transmit waveform of FIG. 8, a second negative feedback loop, including an amplifier 181 which includes components to set the stability of negative feedback, can measure the transmit current during the zero-voltage period 273, and an output 182 of the amplifier 181 can control the timing of, say, time 222 (low-voltage period 271) or time 223 (low-voltage period 271 and high-voltage period 272), so as to maintain the current during the zero-voltage period 273, to be zero.

The current during the zero-voltage period 263 can be controlled by another negative feedback loop, a third negative feedback control electronics including amplifier 183, which includes components to set the stability of negative feedback, which measures the transmit coil current during the zero-voltage period 263, and an output 184 of the amplifier 183 can control the timing of, say, time 211 (period 264), or 212 (period 264 and period 265), or 214 (period 265 and period 266), or time 217 (period 266 and the period 267), or time 219 (period 267 and the high-voltage period 262), so as to maintain the current, during the zero-voltage period 263, to be zero.

These times will be modulated slightly as the inductance of the transmit coil is modulated by the magnetic susceptibility of magnetically mineralised soils as the transmit coil is moved over such soils. Alternatively, a negative feedback loop may control output voltages of power source/s.

Thus, the receive electronics can sample or synchronously demodulate, with sufficient delay following the transition between the high-voltage period and zero-voltage period for the value of (5) to become insignificant, during the zero-voltage periods 273 and 263 so as to produce receive demodulated signal without X contamination.

Advantage is gained by selecting the first voltage to be at least three times greater (say 20 times but can be as low as 3 times with reasonable advantage) in magnitude than either that of the second or any voltage from the third power source or combination, in accordance with the well-known pulse induction theory. Whilst the waveform in FIG. 8 shows just three different negative voltages applied to the transmit coil, the power sources may provide other voltage outputs, and further switches controlled by timing electronics 160 may switch these to the transmit coil.

In another embodiment, the repeating transmit signal cycle may take the form of that produced by the pulse induction system disclosed in U.S. Pat. No. 6,653,838 where the transmit sequence consists of the transmit coil being switched to a second power source of a negative low second voltage (e.g. −5V) for an low-voltage period of roughly a quarter or so of the fundamental period when the transmit coil current increases from zero to a negative peak. This period is then followed by a very short duration high-voltage back-emf period where all the magnetic energy stored in the transmit coil is transferred to a first power source, e.g. a first capacitor, as a charge. The first capacitor may operationally be at a first voltage of say 180V.

Next follows a zero-voltage period when the switching electronics shorts out the transmit coil, and the receiver receives receive signals, for say slightly more than a quarter of the fundamental period. Thereafter, the transmit coil is switched to the first power source for a very short duration low-voltage period so that the resulting discharge of the first power source equals the charge during the charging back-emf (high-voltage) period.

Thereafter, the resulting energy of the magnetic field stored by the transmit coil is transferred to the second power source as a charge for a little less than a quarter of the fundamental period as a high-voltage period. Once the magnetic field becomes zero, the transmit coil is shorted out by the switching electronics for another zero-voltage period for about a quarter of the fundamental period, when the receiver receives receive signals again. Three negative feedback loops are to provide for setting the voltage across the first capacitor, and zero transmit coil current during both the receive periods when the transmit coil is shorted. These three negative feedback loops may control three of the following variables: the durations of the two periods when the transmit coil is switched to the first power source; and the durations of the two periods when the transmit coil is switched to the second power source.

The system described in this embodiment does not depend on a switch-mode power supply to convert energy from the first power source back to the second power source as this action is intrinsic to the waveform because the transmit coil acts as a switching inductor for the switch-mode power supply, although using an additional power supply for the first power source might allow better definition of the “back-emf” (high-voltage) period when the transmit coil is switched to the second power source following a period of the transmit coil switched to the first power source. Alternatively, the first power source may provide the input power, and the second power source may be a passive storage capacitor. This system is referred to herein as a “fully symmetric bipolar system.”

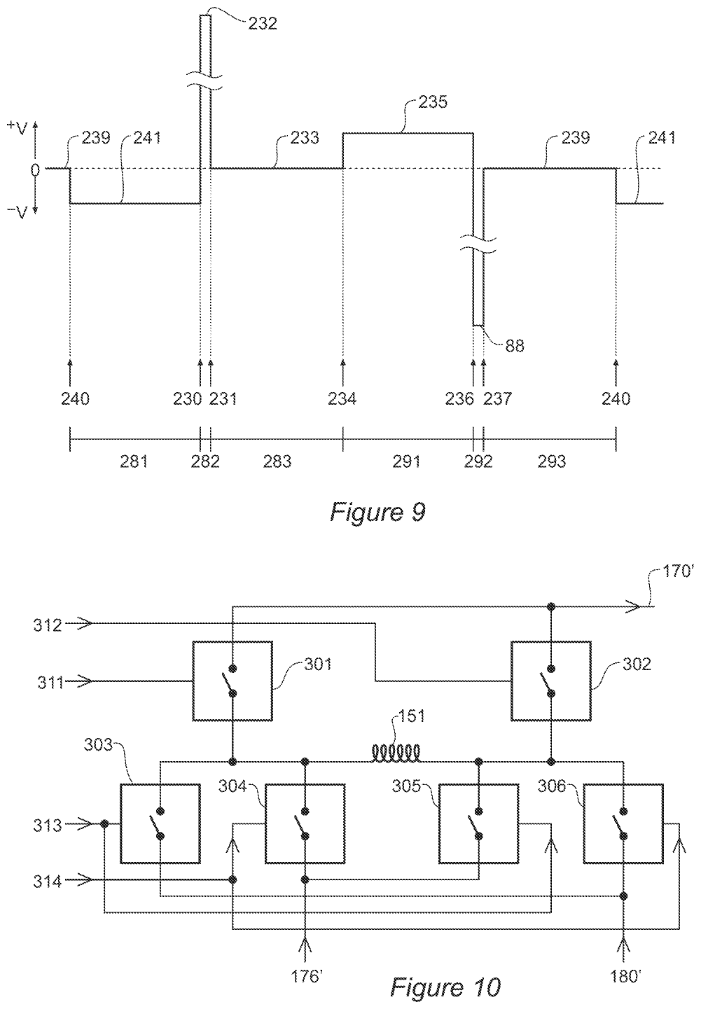

FIG. 9 shows an embodiment of the “bipolar” repeating transmit signal cycle, where the repeating transmit signal cycle includes at least two different sequences, the first sequence including a first low-voltage period, a first high-voltage period and a first zero-voltage period, and the second sequence including a second low-voltage period, a second high-voltage period and a second zero-voltage period. The first and second zero-voltage periods are the first and second receive periods respectively, and at least one of the first low-voltage period, the first high-voltage period and the first zero-voltage period, differs from the respective second low-voltage period, second high-voltage period and second zero-voltage period in at least voltage and/or duration.

Referring to FIG. 9, the high-voltage period 282 commences at time 230 and terminates at time 231 during which the voltage switched to the transmit coil is the first voltage 232. An output impedance of the transmit electronics to the transmit coil is low at least immediately after the transition 231 of the first voltage 232 to zero voltage 233 in response to the switches selecting the first voltage 232 switched to the transmit coil followed by the switches selecting zero volts 233 switched to the transmit coil. The zero-voltage period 283 commences at time 231 and terminates at time 234 during which the voltage switched to the transmit coil is zero volts 233, and during this period the current through the transmit coil is substantially zero. A low-voltage period 291 commences at time 234 and terminates at time 236 during which the voltage switched to the transmit coil is a fifth voltage 235, and during this period the current through the transmit coil increases “positively” with an associated transmit coil circuit time constant. A high-voltage period 292 commences at time 236 and terminates at time 237 during which the voltage switched to the transmit coil is a fourth voltage 238, and during this period, the transmit coil current rapidly decreases to zero owing to the large negative fourth voltage 238. An output impedance of the transmit electronics to the transmit coil is low, at least immediately after the transition 237 of the fourth voltage 238 to zero voltage 239, in response to the switches selecting the fourth voltage 238 switched to the transmit coil followed by the switches selecting zero volts 239 switched to the transmit coil. A zero-voltage period 293 commences at time 237 and terminates at time 240 during which the voltage switched to the transmit coil is zero volts 239, and during this period the current through the transmit coil is substantially zero. A low-voltage period 281 commences at time 240 and terminates at time 230 during which the voltage switched to the transmit coil is the second voltage 241, and during this period the current through the transmit coil increases “negatively” with an associated transmit coil circuit time constant. During the high-voltage period 282 which follows, the transmit coil current rapidly decreases to zero.

Receive electronics 191 (FIG. 6) receives and processes a magnetic field during at least some of the zero-voltage period 283 and the zero-voltage period 293 to produce an indicator signal indicating the presence of a metal within in the magnetic field generated by the transmit coil. This system is referred to herein as a voltage “symmetric bipolar system.” Both the first voltage 232 and the fourth voltage 238 may be provided from the first power source such that the switches switch the same voltage from first power source to the transmit coil as the first voltage and the fourth voltage in an opposite polarity sense. Similarly, both the second voltage 241 and the fifth voltage 235 maybe provided from the second power source such that the switches switch the same voltage from second power source to the transmit coil as the second voltage and the fifth voltage in an opposite polarity sense.

To compare the various systems to the conventional unipolar pulse induction equivalent low impedance drive disclosed in this invention, assume that the waveform 241, 232, 233 of period 281, 282, 283 is repeated twice within the fundamental period shown in FIG. 9, or alternatively, that this is identical to the waveform of FIG. 7 but two such waveforms occur in the same fundamental period as the fundamental period of the waveform of FIG. 9. This system half period of FIG. 7 waveform is referred to herein as a “half fundamental period unipolar system”.

Assume the sequence of 235, 238, 239 of period 291, 292, 293 is a mirror image about zero volts of the sequence 241, 232, 233, of period 281, 282, 283 so the bipolar waveform is symmetric, and the “fully symmetric bipolar system” is of the same fundamental period and the waveform is exactly fully symmetric.

A “full fundamental period unipolar system” may be defined with the fundamental period of the conventional unipolar pulse induction waveform (of FIG. 7) being the same as the “symmetric bipolar system” and “fully symmetric bipolar system,” but half the second voltage so that the transmit coil power dissipation is equivalent assuming a small transmit coil resistance. However, assume this resistance is infinitely small, and that the electronics is ideal.

Assume that the receive circuitry: subtracts an average of the zero-voltage period 283 from an average of the zero-voltage period 293 for the “symmetric bipolar system”; both the “half fundamental period unipolar system” and “full fundamental period unipolar system” receive circuits subtract an average of the first half of the zero-voltage period from an average of the second half of the zero-voltage period; subtracts an average of one of the zero-voltage periods of the “fully symmetric bipolar system” period from an average of the other; so that any net “dc” signal from say moving the coil through the earth's magnetic field is cancelled in each case.

The “bipolar symmetric system” and the “fully symmetric bipolar system” and the “full fundamental period unipolar system” all have a signal gain advantage compared to the “half fundamental period unipolar system” of asymptotically approaching 4 times for very long time constant targets. However, both the “full fundamental period unipolar system” and the “fully symmetric bipolar system” have half the very short time constant gains compared to the “bipolar symmetric system” and the “half fundamental period unipolar system”. Hence, overall the “bipolar symmetric system” offers highest system gain. The electronics of an equivalent “bipolar symmetric system” conventional pulse induction system is relatively complex compared to the low impedance drive invention described herein, and also the low impedance drive offers the advantages described earlier.

The waveform in FIG. 9 can be provided by a different circuit for example such as the partial transmit switching circuit shown in FIG. 10. This circuit includes an “H bridge” switches 301, 302, 303, 304, 305, 306, to replace switches 155 and 156 in FIG. 6. This replacement can be inserted between points 170′, 176′ and 180′ in FIG. 6. Switches 301, 302, 303, 304, 305, 306 are controlled by control electronics 160 through extra control lines 311, 312, 313, 314. The transmit coil 151 current sensing resistor 152 is connected to the “Lo-side” switches 303 and 306. The “Hi-side” switches 301 and 302 are connected to the first power source at 170′. Control lines 311 and 312 act to connect coil 151 to the first power source in opposite polarity senses, and control lines 313 and 314 act to connect coil 151 to the second and third power source in opposite polarity senses. If either switches 303, 305, 166 and 159 are “on”, or switches 304, 306, 166 and 159 are “on,” then there is zero volts across the transmit coil and the transmit coil current may be measured by measuring the voltage across resistor 152 (plus the resistance of switch 159 if the voltage is measured relative to the system ground 153).

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields, optical fields, or any combination thereof

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

1. A method for detecting a metallic target in a soil using a metal detector, the method comprising:
a) generating a repeating transmit signal cycle, the repeating transmit signal cycle including a first receive period and a first non-zero transmit coil reactive voltage period, the first non-zero transmit coil reactive period being different from the first receive period and does not overlap with the first receive period, wherein an absolute average voltage value across a transmit coil during the first non-zero transmit coil reactive voltage period is higher than an absolute average voltage value across the transmit coil during the first receive period;
b) receiving the repeating transmit signal cycle in the transmit coil having an inductance, the transmit coil connected to transmit electronics to generate a transmitted magnetic field;
c) receiving a received magnetic field in a receive coil during the first receive period and providing a received signal induced by the received magnetic field;
d) sensing a current in the transmit coil during the first receive period to determine a modulation of the inductance of the transmit coil;
e) based on the determined modulation of the inductance of the transmit coil, providing a control signal based on the sensed current to change one or both of the magnitude of a voltage and a duration of the first non-zero transmit coil reactive voltage period, without changing a voltage applied across the transmit coil during the first receive period, to maintain the current during the first receive period to be constant, with zero reactive voltage, and of a fixed value from cycle to cycle; and wherein the applied voltage to the transmit coil during the first receive period with zero reactive transmit voltage ignoring temperature effects is constant, not affected by the modulation of the inductance of the transmit coil; and
f) processing the received signal during the first receive period to produce an indicator output signal, the indicator output signal including a signal indicative of the presence of a metallic target in the soil.

2. The method of claim 1, further comprising:
g) compensating for changes of resistances of the transmit electronics and the transmit coil, due to a change of temperature, to minimize an effect of the change of temperature upon the current during the first receive period.

3. The method of claim 1, wherein the repeating transmit signal cycle includes a high-voltage period, the high-voltage period is a non-zero transmit coil reactive voltage period, and is followed by a low-voltage period and at least another period of non-zero transmit coil reactive voltage period; the first receive period includes the low-voltage period, and an average value of the transmit coil current during the low-voltage period of every repeating transmit signal cycle is non-zero.

4. The method of claim 1, wherein the repeating transmit signal cycle includes a low-voltage period, the low-voltage period followed by a high-voltage period, and the high-voltage period followed by a zero-voltage period; the first receive period includes the zero-voltage period, and an average value of the transmit coil current during the zero-voltage period of every repeating transmit signal cycle is zero.

5. The method of claim 1, wherein the repeating transmit signal cycle further includes a second receive period, an average value of the current during the first receive period is substantially different from an average value of the current during the second receive period.

6. The method of claim 5, wherein the repeating transmit signal cycle includes at least two different sequences, a first sequence and a second sequence, the first sequence including a first high-voltage period and a first low-voltage period, and the second sequence including a second high-voltage period and a second low-voltage period, the first receive period and the second receive period include the first low-voltage period and the second low-voltage period respectively, and the second sequence is opposite in polarity to the first sequence.

7. The method of claim 6, wherein the current waveform of the repeating transmit signal cycle is substantially a square wave.

8. The method of claim 5, wherein the repeating transmit signal cycle includes at least two different sequences, a first sequence and a second sequence, the first sequence including a first low-voltage period, a first high-voltage period and a first zero-voltage period, and the second sequence including a second low-voltage period, a second high-voltage period and a second zero-voltage period, wherein the first receive period and the second receive period include the first zero-voltage period and the second zero-voltage period respectively, and a voltage and/or duration of at least one of the first low-voltage periods, the first high-voltage period and the first zero-voltage period, differs from a voltage and/or duration of the second low-voltage period, second high-voltage period and second zero-voltage period respectively.

9. The method of claim 8, wherein an average voltage of the first low-voltage period is of opposite polarity to an average voltage of the second low-voltage period, and an average voltage of the first high-voltage period is of opposite polarity to an average voltage of the second high-voltage period.

10. The method of claim 9, wherein an output impedance of the transmit electronics connected to the transmit coil is less than three times an equivalent series resistance of the transmit coil at least immediately after the beginning of the first receive period.

11. The method of claim 1, wherein the processing of the received signal by receive electronics includes sampling and/or synchronous demodulation followed by averaging and/or low pass filtering to substantially remove signals with frequency of the repeating transmit signal cycle, to produce a receive reactive signal and a receive resistive signal, the receive reactive signal being responsive to non-dissipative components coupling between the transmitted magnetic field and the receive magnetic field, and the receive resistive signal being responsive to dissipative components coupling between the transmitted magnetic field and the receive magnetic field, wherein the receive reactive signal is differentiated with respect to time to give a differentiated receive reactive signal; a first portion of the differentiated receive reactive signal is subtracted from the receive resistive signal to give a modified receive resistive signal, the first portion is selected to approximately cancel any component of the receive resistive signal proportional to the differentiated receive reactive signal; and the modified receive resistive signal is further processed by the receive electronics to produce an indicator signal.

12. The method of claim 3, wherein an absolute average voltage value across the transmit coil during the high-voltage period is at least about three times an absolute average voltage value across the transmit coil during the low-voltage period.

13. The method of claim 3, wherein an average absolute value of a voltage during a high-voltage period is within the range of about 10 volts to about 400 volts.

14. The method of claim 3, wherein an average absolute value of a voltage during a low-voltage period is within the range of about 0.1 volts to about 15 volts.
